(19) United States
(12) Patent Application Publication
(10) Pub. No.: US 2018/0354486 A1
(43) Pub. Date: Dec. 13, 2018

(54) ABNORMALITY DIAGNOSIS DEVICE

(71) Applicants: ADVICS CO., LTD., Kariya-shi, Aichi-ken (JP); TOYOTA JIDOSHA KABUSHIKI KAISHA, Toyota-shi, Aichi-ken (JP)

(72) Inventors: Yoshio MASUDA, Anjo-shi, Aichi-ken (JP); Takahiro OKANO, Chiryu-shi, Aichi-ken (JP)

(73) Assignees: ADVICS CO., LTD., Kariya-shi, Aichi-ken (JP); TOYOTA JIDOSHA KABUSHIKI KAISHA, Toyota-shi, Aichi-ken (JP)

(21) Appl. No.: 15/778,495

(22) PCT Filed: Nov. 24, 2016
(86) PCT No.: PCT/JP2016/084863

§ 371 Date: May 23, 2018

(30) Foreign Application Priority Data
Nov. 27, 2015 (JP) 2015-231365

(51) Int. Cl. B60T 17/22; G07C 5/08; B60T 13/16; B60T 13/68; B60T 15/02

(52) U.S. Cl. CPC B60T 17/22; G07C 5/0808; B60T 2220/04; B60T 13/686; B60T 15/028; B60T 13/161

(57) ABSTRACT

An abnormality diagnosis device to be used in a vehicle braking device equipped with a low pressure source connected to a reaction force chamber in a predetermined condition, a master cylinder, a drive portion, and a control portion. The abnormality diagnosis device includes: a diagnosis portion for performing an abnormality diagnosis on the basis of the relationship between the reaction force hydraulic pressure and the operation amount of a braking operation member, and/or the relationship between a target value and an actual value; and a judging portion for judging whether or not the reaction force chamber state pertaining to the hydraulic pressure and/or fluid amount thereof is in a predetermined insufficient state or in a predetermined excess state. Furthermore, when the judging portion judges that the reaction force chamber state is in a predetermined insufficient state or in a predetermined excess state, the diagnosis portion stops the abnormality diagnosis.

### TECHNICAL FIELD

This invention relates to an abnormality diagnosis device adapted for a vehicle braking device.

### BACKGROUND ART

Generally, a vehicle braking device is equipped with an abnormality diagnosis device (for example, ECU) which executes an abnormality diagnosis of a system. The abnormality diagnosis is executed based on at least either one of “the relationship between the operating amount of the brake operating member and the reaction force hydraulic pressure” and “the relationship between the target hydraulic pressure and the actual hydraulic pressure”. For example, the reaction force hydraulic pressure is generated in response to the operating amount of the brake operating member and if the reaction force hydraulic pressure is too large or too small relative to the operating amount, it can be diagnosed that an abnormality is generated in a system. Further, the ECU executes the control in which the actual hydraulic pressure is approximated to the target hydraulic pressure and if the actual hydraulic pressure is too large or too small compared to the target hydraulic pressure, it can be also diagnosed that an abnormality is generated in a device. As explained, in the abnormality diagnosis device, the abnormality diagnosis is executed based on the above relationship. It is noted here that a vehicle braking device is disclosed in for example, Japanese Patent Publication No. JP2012-16984, in which the reaction force chamber where the reaction hydraulic pressure is generated and a low pressure source such as a reservoir or the like establish fluid communication therebetween under a predetermined condition.

### CITATION LIST

### Patent Literature

[Patent Literature 1] JP2012-16984 A

### SUMMARY OF INVENTION

### Technical Problem(s)

However, according to the conventional abnormality diagnosis device, such fluid communication between the reaction force chamber and the low pressure source was not considered. Therefore, in such abnormality diagnosis device, there still exists a need for improvement in diagnosis accuracy. The inventors of this application focused on this point to complete this invention.

Accordingly, this invention was made in consideration with the above-mentioned situation and the objective of the invention is to provide an abnormality diagnosis device which can improve the accuracy of the abnormality diagnosis.

### Solution to Problem(s)

The abnormality diagnosis device according to the invention applied to a vehicle braking device which includes a reaction force chamber in which a reaction force hydraulic pressure is generated in response to an operating amount of a brake operating member, a low pressure source which communicates with the reaction force chamber under a predetermined condition, a master cylinder having a master chamber in which a master hydraulic pressure is generated by being driven by a master piston, a driving portion which generates a driving force for driving the master piston in response to the operating amount of the brake operating member and a control portion which sets a target value of the driving force or the master hydraulic pressure based on at least one of the operating amount of the brake operating member and an operating force of the brake operating member and controls the driving portion to make an actual value of the driving force or the master hydraulic pressure relative to the target value approximate the target value. The diagnosis device includes a diagnosis portion which performs an abnormality diagnosis based on at least one of a relationship between the operating amount of the brake operating member and the reaction force hydraulic pressure and a relationship between the target value and the actual value and a judging portion which judges whether a state of the reaction force chamber with respect to at least one of a hydraulic pressure and an amount of fluid therein is in a predetermined insufficient state or in a predetermined excess state, wherein the diagnosis portion stops performance of the abnormality diagnosis when the state of the reaction force chamber with respect to the at least one of the hydraulic pressure and the amount of fluid therein is judged by the judging portion to be in the predetermined insufficient state or in the predetermined excess state.

### Effect of Invention

According to the vehicle braking device in which the reaction force chamber and the low pressure source are in fluid communication under a predetermined condition, there may be generated an insufficient fluid state or an excess fluid state in the reaction force chamber derived from establishment or interruption of the fluid communication therebetween. In such case, since the various responses to the operating amount of the brake operating member are different from the normal state, such responses may influence on the result of the abnormality diagnosis to thereby miss-judge that there exists an abnormality in spite of a normal state. According to the invention, however, when the fluid state in the reaction force chamber becomes an insufficient fluid state or an excess fluid state, such state is detected to stop performance of the abnormality diagnosis. Thus, a miss-judge that there exists an abnormality in spite of a normal state is suppressed. In other words, according to the invention, the abnormality diagnosis can be performed when the state of the reaction force chamber is in a normal state. This can improve the accuracy of abnormality diagnosis.

### BRIEF EXPLANATION OF ATTACHED DRAWINGS

FIG. 1 is a structural view of a vehicle braking device according to an embodiment of the invention, to which the invention is applied;

FIG. 2 is a cross sectional view of a regulator according to the embodiment;

FIG. 3 is an explanatory view explaining a relationship between the stroke and the reaction force hydraulic pressure;

FIG. 4 is an explanatory view explaining a relationship between the target servo pressure and the actual servo pressure;

FIG. 5 is an explanatory view explaining an example of fluid amount change in the reaction force chamber; and

FIG. 6 is a flowchart explaining a flow of the abnormality diagnosis according to the embodiment.

### EMBODIMENTS FOR IMPLEMENTING INVENTION

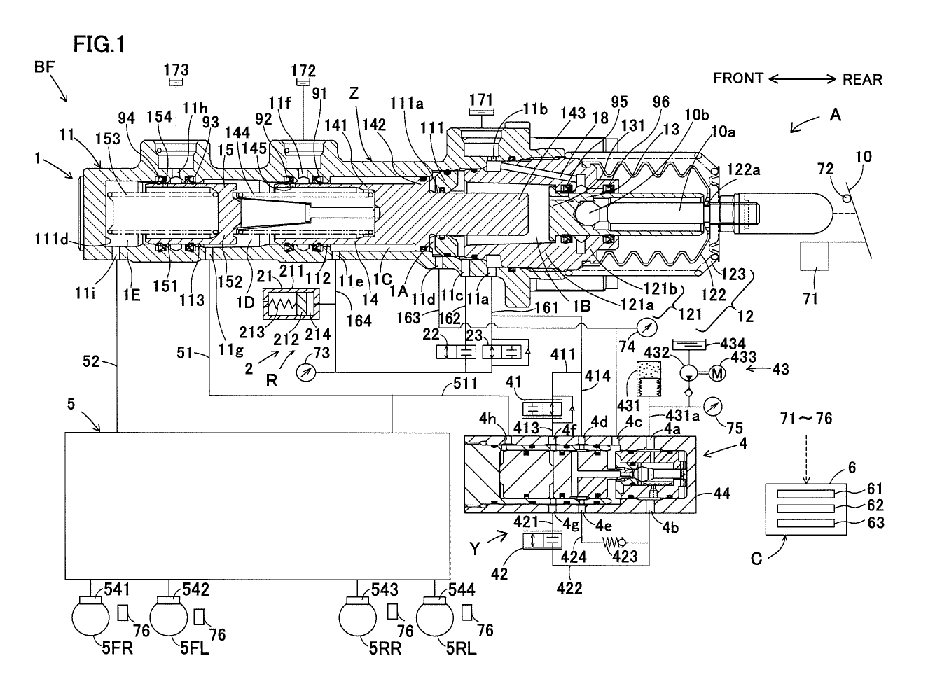

The embodiments of the invention will be explained hereinafter with reference to the attached drawings. It is noted that each drawing used for explanation shows a conceptual drawing and the shape of each portion in the drawings does not necessarily indicate an accurate shape in practical use. As shown in FIG. 1, the braking device A for a vehicle according to the embodiment is formed by a hydraulic pressure braking force generating device BF which generates a hydraulic pressure braking force at vehicle wheels 5FR, 5FL, 5RR and 5RL and a brake ECU 6 which controls the hydraulic pressure braking force generating device BF. The brake ECU 6 corresponds to the abnormality diagnosis device C and the abnormality diagnosis device C is applied to the vehicle braking device A.

(Hydraulic Pressure Braking Force Generating Device BF)

The hydraulic pressure braking force generating device BF is formed as shown in FIG. 1, by a master cylinder 1, a reaction force generating device 2, a first control valve 22 (corresponding to electromagnetic valve), a second control valve 23, a servo pressure generating device 4, an actuator 5, wheel cylinders 541 through 544 and various sensors 71 through 76.

(Master Cylinder 1)

The master cylinder 1 is a portion which supplies the actuator 5 with a fluid (an operating fluid) (in response to the operating amount of a brake pedal 10 (corresponding to “brake operating member”) and is formed by a main cylinder 11, a cover cylinder 12, an input piston 13, a first master piston 14 and a second master piston 15 and so on. The brake pedal 10 may be of any type of brake operating means that can perform brake operation by a driver of the vehicle.

The main cylinder 11 is formed in a substantially bottomed cylinder shape housing having a bottom surface closed at a front end and an opening at a rear end thereof. The main cylinder 11 includes therein an inner wall portion 111, which extends inwardly with a shape of flange at a rear side in the inner peripheral side of the main cylinder 11. An inner circumferential surface of the inner wall portion 111 is provided with a through hole 111a at a central portion thereof, penetrating through the inner wall portion in front and rearward direction. The main cylinder 11 is provided therein at portions closer to the front end than the inner wall portion 111 with a small diameter portion 112 (rear) and a small diameter portion 113 (front), each of which inner diameter is set to be slightly smaller than the inner diameter of the inner wall portion 111. In other words, the small diameter portions 112, 113 project from the inner circumferential surface of the main cylinder 11 having an inwardly annularly shaped profile. The first master piston 14 is disposed inside the main cylinder 11 and is slidably movable along the small diameter portion 112 in the axial direction. Similarly, the second master piston 15 is disposed inside the main cylinder 11 and is slidably movable along the small diameter portion 113 in the axial direction.

The cover cylinder 12 includes an approximately cylindrical portion 121, a tubular bellow boots 122 and a cup-shaped compression spring 123. The cylindrical portion 121 is arranged at a rear end side of the main cylinder 11 and is coaxially fitted into the rear side opening of the main cylinder 11. An inner diameter of a front portion 121a of the cylindrical portion 121 is formed to be greater than an inner diameter of the through hole 111a of the inner wall portion 111. Further, the inner diameter of the rear portion 121b is formed to be smaller than the inner diameter of the front portion 121a.

The dust prevention purpose boots 122 is of tubular bellow shaped and is extendible or compressible in front and rearward directions. The front side of the boots 122 is assembled to be in contact with the rear end side opening of the cylindrical portion 121. A through hole 122a is formed at a central portion of the rear of the boots 122. The compression spring 123 is a coil shaped biasing member arranged around the boots 122. The front side of the compression spring 123 is in contact with the rear end of the main cylinder 11 and the rear side of the compression spring 123 is disposed with a preload adjacent to the through hole 122a of the boots 122. The rear end of the boots 122 and the rear end of the compression spring 123 are connected to an operating rod 10a. The compression spring 123 biases the operating rod 10a in a rearward direction.

The input piston 13 is a piston configured to slidably move inside the cover cylinder 12 in response to an operation of the brake pedal 10. The input piston 13 is formed in a substantially bottomed cylinder shape having a bottom surface at a front portion thereof and an opening at a rear portion thereof. A bottom wall 131 forming the bottom surface of the input piston 13 has a greater diameter than the diameters of the other parts of the input piston 13. The input piston 13 is arranged at the rear end portion 121b of the cylindrical potion 121 and is slidably and fluid-tightly movable in an axial direction and the bottom wall 131 is assembled into an inner peripheral side of the front portion 121a of the cylindrical portion 121.

The operating rod 10a operable in association with the brake pedal 10 is arranged inside of the input piston 13. A pivot 10b is provided at a tip end of the operating rod 10a so that the pivot 10b can push the input piston 13 toward front side. The rear end of the operating rod 10a projects towards outside through the rear side opening of the input piston 13 and the through hole 122a of the boots 122 and is connected to the brake pedal 10. The operating rod 10a moves in response to the depression operation of the brake pedal 10. More specifically, when the brake pedal 10 is depressed, the operating rod 10a advances in a forward direction, while compressing the boots 122 and the compression spring 123 in the axial direction. The input piston 13 also advances in response to the forward movement of the operating rod 10a.

The first master piston 14 is arranged in the inner wall portion 111 of the main cylinder 11 and is slidably movable in the axial direction. The first master piston 14 includes a pressurizing cylindrical portion 141, a flange portion 142 and a projection portion 143 in order from the front and the cylindrical portion 141, the flange portion 142 and the projection portion 143 are formed integrally as a unit. The pressurizing cylindrical portion 141 is formed in a substantially bottomed cylinder shape having an opening at a front portion thereof and a bottom wall at a rear portion thereof. The pressurizing cylindrical portion 141 includes a clearance formed with the inner peripheral surface of the main cylinder 11 and is slidably in contact with the small diameter portion 112. A coil spring-shaped biasing member 144 is provided in the inner space of the pressurizing cylindrical portion 141 between the first master piston 14 and the second master piston 15. The first master piston 14 is biased in a rear direction by the biasing member 144. In other words, the first master piston 14 is biased by the biasing member 144 towards a predetermined initial position.

The flange portion 142 is formed to have a greater diameter than the diameter of the pressurizing cylindrical portion 141 and is slidably in contact with the inner peripheral surface of the main cylinder 11. The projection portion 143 is formed to have a smaller diameter than the diameter of the flange portion 142 and is slidably in fluid-tightly contact with the through hole 111a of the inner wall portion 111. The rear end of the projection portion 143 projects into an inner space of the cylindrical portion 121, passing through the through hole 111a and is separated from the inner peripheral surface of the cylindrical portion 121. The rear end surface of the projection portion 143 is separated from the bottom wall 131 of the input piston 13 and the separation distance is formed to be variable.

It is noted here that a “first master chamber 1D” is defined by the inner peripheral surface of the main cylinder 11, a front side of the pressurizing cylindrical portion 141 of the first master piston 14 and a rear side of the second master piston 15. A rear chamber which is located further rearward of the first master chamber 1D, is defined by the inner peripheral surface (inner peripheral portion) of the main cylinder 11, the small diameter portion 112, a front surface of the inner wall portion 111 and the outer peripheral surface of the first master piston 14. The front-end portion and the rear end portion of the flange portion 142 of the first master piston 14 separate the rear chamber into a front portion and a rear portion and a “second hydraulic pressure chamber 1C” is defined at the front side of the rear chamber and a “servo chamber (drive chamber) 1A” is defined at the rear side of the rear chamber. The main cylinder 11 and the first master piston 14 form a second hydraulic pressure chamber forming portion Z which forms the second hydraulic pressure chamber 1C. The second hydraulic pressure chamber 1C formed by the second hydraulic pressure chamber forming portion Z decreases the volume thereof by the advance movement of the first master piston 14 and increases the volume thereof by the retreatment movement of the first master piston 14. Further, a “first hydraulic pressure chamber 1B” is defined by the inner peripheral surface of the main cylinder 11, a rear surface of the inner wall portion 111, an inner peripheral surface (inner peripheral portion) of the front portion 121a of the cylindrical portion 121, the projection portion 143 (rear end portion) of the first master piston 14 and the front end of the input piston 13.

The second master piston 15 is coaxially arranged within the main cylinder 11 at a location forward of the first master piston 14 and is slidably movable in an axial direction to be in slidable contact with the small diameter portion 113. The second master piston 15 is formed as a unit with a tubular pressurizing cylindrical portion 151 in a substantially bottomed cylinder shape having an opening at a front portion thereof and a bottom wall 152 which closes the rear end of the tubular pressurizing cylindrical portion 151. The bottom wall 152 supports the biasing member 144 with the first master piston 14. A coil spring-shaped biasing member 153 is disposed in the inner space of the pressurizing cylindrical portion 151 between the second piston 15 and a closed inner bottom surface 111d of the main cylinder 11. The second master piston 15 is biased by the biasing member 153 in a rearward direction. In other words, the second master piston 15 is biased by the biasing member 153 towards a predetermined initial position. A “second master chamber 1E” is defined by the inner peripheral surface of the main cylinder 11, the inner bottom surface 111d and the second master piston 15.

Ports 11a through 11i, which connect the inside and the outside of the master cylinder 1, are formed at the master cylinder 1. The port 11a is formed on the main cylinder 11 at a location rearward of the inner wall portion 111. The port 11b is formed on the main cylinder 11 opposite to the port 11a in the axial direction at approximately the same location. The port 11a and the port 11b are in communication through an annular space formed between the inner circumferential surface of the main cylinder 11 and the outer circumferential surface of the cylindrical portion 121. The port 11a and the port 11b are connected to a conduit 161 and also connected to a reservoir 171.

The port 11b is in communication with the first hydraulic pressure chamber 1B via a passage 18 formed at the cylindrical portion 121 and the input piston 13. The fluid communication through the passage 18 is interrupted when the input piston 13 advances forward. In other words, when the input piston 13 advances forward, the fluid communication between the first hydraulic pressure chamber 1B and the reservoir 171 is interrupted.

The port 11c is formed ata location rearward of the inner wall portion 111 and forward of the port 11a and the port 11c connects the first hydraulic pressure chamber 1B with a conduit 162. The port 11d is formed at a location forward of the port 11c and connects the servo chamber 1A with a conduit 163. The port 11e is formed at a location forward of the port 11d and connects the second hydraulic pressure chamber 1C with a conduit 164.

The port 11f is formed between the sealing members 91 and 92 provided at the small diameter portion 112 and connects a reservoir 172 with the inside of the main cylinder 11. The port 11f is in communication with the first master chamber 1D via a passage 145 formed at the first master piston 14. The passage 145 is formed at a location where the port 11f and the first master chamber 1D are disconnected from each other when the first master piston 14 advances forward. The port 11g is formed at a location forward of the port 11f and connects the first master chamber 1D with a conduit 51.

The port 11h is formed between the sealing members 93 and 94 provided at the small diameter portion 113 and connects a reservoir 173 with the inside of the main cylinder 11. The port 11h is in communication with the second master chamber 1E via a passage 154 formed at the pressurizing cylindrical portion 151 of the second master piston 15. The passage 154 is formed at a location where the port 11h and the second master chamber 1E are disconnected from each other when the second master piston 15 advances forward. The port 11i is formed at a location forward of the port 11h and connects the second master chamber 1E with a conduit 52.

Sealing members, such as O-rings and the like (see black circles indicated in the drawings) are appropriately provided within the master cylinder 1. The sealing members 91 and 92 are provided at the small diameter portion 112 and are liquid-tightly in contact with the outer circumferential surface of the first master piston 14. Similarly, the sealing members 93 and 94 are provided at the small diameter portion 113 and are liquid-tightly in contact with the outer circumferential surface of the second master piston 15. Additionally, sealing members 95 and 96 are provided between the input piston 13 and the cylindrical portion 121. These sealing members are cup-shaped sealing and each cross-section thereof is formed to be in a C-character.

The stroke sensor 71 is a sensor which detects the operating amount (stroke) of the brake pedal 10 operated by a driver of the vehicle and transmits the detection result to the brake ECU 6. The brake stop switch 72 is a switch which detects whether the brake pedal 10 is depressed or not, using a binary signal and the detected signal is sent to the brake ECU 6.

(Reaction Force Generating Device 2)

The reaction force generating device 2 is a device which generates a reaction force against the operation force generated when the brake pedal 10 is depressed. The reaction force generating device 2 is formed mainly by a stroke simulator 21. The stroke simulator 21 generates a reaction force hydraulic pressure in the first hydraulic pressure chamber 1B and the second hydraulic pressure chamber 1C in response to the operation of the brake pedal 10. The stroke simulator 21 is configured in such a manner that a piston 212 is fitted into a cylinder 211 while being allowed to slidably move therein. The piston 212 is biased in the forward side direction by a compression spring 213 and a hydraulic pressure chamber 214 is formed at a rear surface side of the piston 212. The hydraulic pressure chamber 214 is connected to the second hydraulic pressure chamber 1C via a conduit 164 and the port 11e, and is connected further to the first control valve 22 and the second control valve 23 via the conduit 164. At least the second hydraulic pressure chamber 1C forms a reaction force chamber which generates the reaction hydraulic pressure. The first hydraulic pressure chamber 1B can be referred to as a separation chamber which separates the first piston 14 and the input piston 13 from each other.

(First Control Valve 22)

The first control valve 22 is an electromagnetic valve which is structured to close under non-energized state (normally closed type electromagnetic valve) and opening and closing operations thereof are controlled by the brake ECU 6. The first control valve 22 is disposed between the conduit 164 and the conduit 162 for communication therebetween. The conduit 164 is connected to the second hydraulic pressure chamber 1C via the port 11e and the conduit 162 is connected to the first hydraulic pressure chamber 1B via the port 11c. The first hydraulic pressure chamber 1B becomes in hydraulically valve-closed state when the first control valve 22 closes. The conduits 164 and 162 are formed for establishing fluid communication between the first hydraulic pressure chamber 1B and the second hydraulic pressure chamber 1C.

The first control valve 22 is closed under non-energized state where an electricity is not applied and under this state, communication between the first hydraulic pressure chamber 1B and the second hydraulic pressure chamber 1C is interrupted. Due to the closure of the first hydraulic pressure chamber 1B, the fluid is nowhere to flow and the input piston 13 and the first master piston 14 are moved integrally keeping a constant separation distance therebetween. The first control valve 22 is open under the energized state where an electricity is applied and under such state, the communication between the first hydraulic pressure chamber 1B and the second hydraulic pressure chamber 1C is established. Thus, the volume changes in the first hydraulic pressure chamber 1B and the second hydraulic pressure chamber 1C due to the advancement and retreatment of the first master piston 14 can be absorbed by the transferring of the fluid.

The pressure sensor 73 is a sensor which detects the reaction force hydraulic pressure of the second hydraulic pressure chamber 1C and the first hydraulic pressure chamber 1B and is connected to the conduit 164. The pressure sensor 73 detects the pressure of the second hydraulic pressure chamber 1C while the first control valve 22 is in a closed state and also detects the pressure of the first hydraulic pressure chamber 1B while the first control valve 22 is in an open state. The pressure sensor 73 sends the detected signal to the brake ECU 6.

(Second Control Valve 23)

The second control valve 23 is an electromagnetic valve which is structured to open under a non-energized state and the opening and closing operations thereof are controlled by the brake ECU 6. The second control valve 23 is disposed between the conduit 164 and the conduit 161 for establishing fluid communication therebetween. The conduit 164 is in communication with the second hydraulic pressure chamber 1C via the port 11e and the conduit 161 is in communication with the reservoir 171 via the port 11a. Accordingly, the second control valve 23 establishes the communication between the second hydraulic pressure chamber 1C and the reservoir 171 under the non-energized state thereby generating no reaction force hydraulic pressure but the second control valve 23 interrupts the communication therebetween under the energized state thereby generating the reaction force hydraulic pressure. The pressure of the reservoirs 171 to 173 is the atmospheric pressure.

(Servo Pressure Generating Device 4)

The servo pressure generating device 4 is formed by a pressure decreasing valve 41, a pressure increasing valve 42, a pressure supplying portion 43 and a regulator 44. The pressure decreasing valve 41 is a valve structured to open under a non-energized state (normally open valve) and the flow-rate (or, the pressure) thereof is controlled by the brake ECU 6. One end of the pressure decreasing valve 41 is connected to the conduit 161 via the conduit 411 and the other end thereof is connected to the conduit 413. In other words, the one end of the pressure decreasing valve 41 is connected to the reservoir 171 via the conduits 411 and 161 and ports 11a and 11b. The pressure decreasing valve 41 prevents the fluid in the first pilot chamber 4D from flowing out by valve closing operation, which will be explained later in detail. It is noted here that the reservoirs 171 and 434 (or the reservoirs 171 through 173 and 434) are formed by one reservoir.

The pressure increasing valve 42 is an electromagnetic valve structured to close under a non-energized state (normally closed valve) and the flow-rate (or pressure) thereof is controlled by the brake ECU 6. One end of the pressure increasing valve 42 is connected to the conduit 421 and the other end thereof is connected to the conduit 422. The pressure supplying portion 43 is a portion which supplies the regulator 44 with mainly a highly pressurized fluid. The pressure supplying portion 43 includes the accumulator 431 (“high pressure source”), the pump 432, the motor 433 and the reservoir 434.

The accumulator 431 is a tank in which the highly pressurized fluid is accumulated. The accumulator 431 is connected to the regulator 44 and the pump 432through the conduit 431a. The pump 432 is driven by the motor 433 and supplies the fluid which has been reserved in the reservoir 434 to the accumulator 431. The pressure sensor 75 provided in the conduit 431a detects the accumulator hydraulic pressure in the accumulator 431 and sends the detected signal to the brake ECU 6. The accumulator hydraulic pressure correlates with the accumulated fluid amount accumulated in the accumulator 431.

When the pressure sensor 75 detects that the accumulator hydraulic pressure drops to a value equal to or lower than a predetermined value, the motor 433 is driven on the basis of a control signal from the brake ECU 6, and the hydraulic pressure pump 432 pumps the fluid to the accumulator 431 thereby to recover a pressure up to the value equal to or more than a predetermined value.

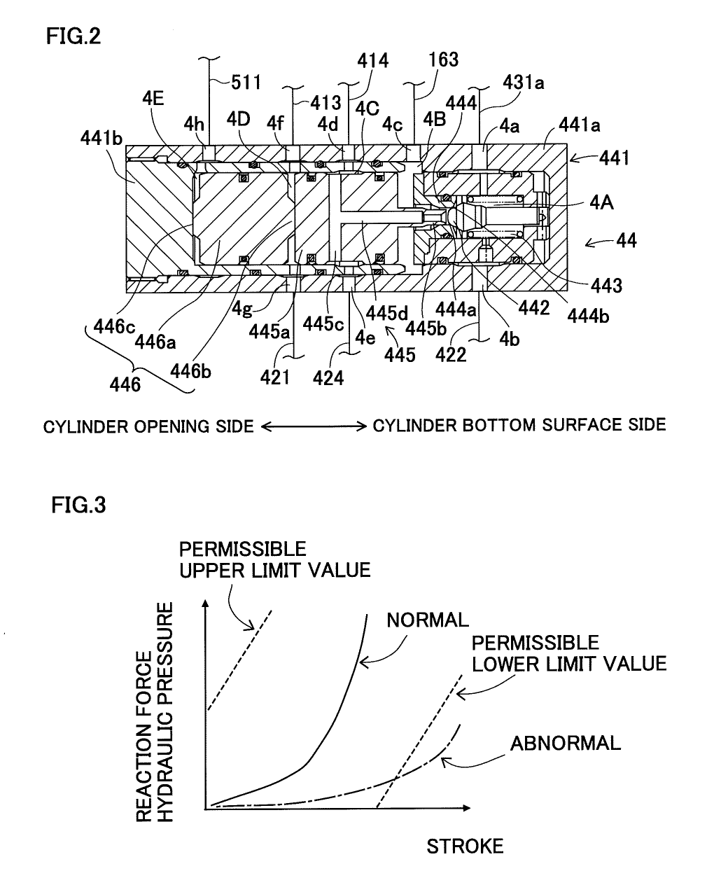

The regulator 44 (pressure adjusting device) includes a cylinder 441, a ball valve 442, a biasing portion 443, a valve seat portion 444, a control piston 445 and a sub-piston 446 as shown in FIG. 2. The cylinder 441 includes a cylinder case 441a formed in a substantially bottomed cylinder-shape having a bottom surface at one end thereof (at the right side in the drawing) and a cover member 441b closing an opening of the cylinder case 441a (at the left side thereof in the drawing). It is noted here that the cylinder case 441a is provided with a plurality of ports 4a through 4h through which the inside and the outside of the cylinder case 441a are in communication. The cover member 441b is formed in a substantially bottomed cylinder-shape having a bottom surface and is provided with a plurality of ports which is arranged at positions facing to the respective cylindrical ports 4d through 4h provided on the cylindrical portion.

The port 4a is connected to the conduit 431a. The port 4b is connected to the conduit 422. The port 4c is connected to a conduit 163. The conduit 163 connects the servo chamber 1A and the outlet port 4c. The port 4d is connected to the conduit 161 via the conduit 414. The port 4e is connected to the conduit 424 and further connected to the conduit 422 via a relief valve 423. The port 4f is connected to the conduit 413. The port 4g is connected to the conduit 421. The port 4h is connected to a conduit 511, which is branched from the conduit 51.

The ball valve 442 is a valve having a ball shape and is arranged at the bottom surface side (which will be hereinafter referred to also as a cylinder bottom surface side) of the cylinder case 441a inside the cylinder 441. The biasing portion 443 is formed by a spring member biasing the ball valve 442 towards the opening side (which will be hereinafter referred to also as a cylinder opening side) of the cylinder case 441a, and is provided at the bottom surface of the cylinder case 441a. The valve seat portion 444 is a wall member provided at the inner peripheral surface of the cylinder case 441a and divides the cylinder inside into two parts, the cylinder opening side and the cylinder bottom surface side. A through passage 444a, through which the cylinder opening side and the cylinder bottom surface side spaces are in communication, is formed at a central portion of the valve seat portion 444. The valve member 444 holds the ball valve 442 from the cylinder opening side in a manner that the biased ball valve 442 closes the through passage 444a. A valve seat surface 444b is formed at the opening of the cylinder bottom surface side of the through passage 444a and the ball valve 442 is detachably seated on (in contact with) the valve seat surface 444b.

A space defined by the ball valve 442, the biasing portion 443, the valve seat portion 444 and the inner circumferential surface of the cylinder case 441a at the cylinder bottom surface side is referred to as a “first chamber 4A”. The first chamber 4A is filled with the fluid and is connected to the conduit 431a via the port 4a and to the conduit 422 via the port 4b.

The control piston 445 includes a main body portion 445a formed in a substantially columnar shape and a projection portion 445b formed in a substantially columnar shape having a diameter smaller than the diameter of the main body portion 445a. The main body portion 445a is arranged in the cylinder 441 in a coaxial and liquid-tight manner on the cylinder opening side of the valve seat portion 444, the main body portion 445a being slidably movable in an axial direction. The main body portion 445a is biased towards the cylinder opening side by means of a biasing member (not shown). A passage 445c is formed at a substantially intermediate portion of the main body portion 445a in a cylinder axis direction. The passage 445c extends in the radial direction (in an up-and-down direction as viewed in the drawing) and both ends of the passage 445c are open to the circumferential surface of the main body portion 445a. A portion of an inner circumferential surface of the cylinder 441 corresponding to an opening position of the passage 445c is provided with the port 4d and is recessively formed. The recessed space portion forms a “third chamber 4C”.

The projection portion 445b projects towards the cylinder bottom surface side from a center portion of an end surface of the cylinder bottom surface side of the main body portion 445a. The projection portion 445b is formed so that the diameter thereof is smaller than the diameter of the through passage 444a of the valve seat portion 444. The projection portion 445b is coaxially provided relative to the through passage 444a. A tip end of the projection portion 445b is spaced apart from the ball valve 442 towards the cylinder opening side by a predetermined distance. A passage 445d is formed at the projection portion 445b so that the passage 445d extends in the cylinder axis direction and opens at a center portion of an end surface of the projection portion 445b. The passage 445d extends into the inside of the main body portion 445a and is connected to the passage 445c.

A space defined by the end surface of the cylinder bottom surface side of the main body portion 445a, an outer peripheral surface of the projection portion 445b, the inner circumferential surface of the cylinder 441, the valve seat portion 444 and the ball valve 442 is referred to as a “second chamber 4B”. The second chamber 4B is in communication with the ports 4d and 4e via the passages 445d and 445c and the third chamber 4C, under non-contact state.

The sub-piston 446 includes a sub main body portion 446a, a first projection portion 446b and a second projection portion 446c. The sub main body portion 446a is formed in a substantially columnar shape. The sub main body portion 446a is arranged within the cylinder 441 in a coaxial and liquid-tight manner on the cylinder opening side of the main body portion 445a. The sub main body portion 446a is slidably movable in the axial direction.

The first projection portion 446b is formed in a substantially columnar shape having a diameter smaller than the diameter of the sub main body portion 446a and projects from a center portion of an end surface of the cylinder bottom surface side of the sub main body portion 446a. The first projection portion 446b is in contact with the end surface of the cylinder bottom surface side of the sub main body portion 446a. The second projection portion 446c is formed in the same shape as the first projection portion 446b. The second projection portion 446c projects from a center portion of an end surface of the cylinder opening side of the sub main body portion 446a. The second projection portion 446c is in contact with the cover member 441b.

A space defined by the end surface of the cylinder bottom surface side of the sub main body portion 446a, an outer peripheral surface of the first projection portion 446b, an end surface of the cylinder opening side of the control piston 445 and the inner circumferential surface of the cylinder 441 is referred to as a “first pilot chamber 4D”. The first pilot chamber 4D is in communication with the pressure decreasing valve 41 via the port 4f and the conduit 413 and is in fluid communication with the pressure increasing valve 42 via the port 4g and the conduit 421.

A space defined by the end surface of cylinder opening side of the sub main body portion 446a, an outer peripheral surface of the second projection portion 446c, the cover member 441b and the inner circumferential surface of the cylinder 441 is referred to as a “second pilot chamber 4E”. The second pilot chamber 4E is in communication with the port 11g via the port 4h and the conduits 511 and 51. Each of the chambers 4A through 4E is filled with the fluid. The pressure sensor 74 is a sensor that detects the pressure (hydraulic pressure in the servo chamber 1A: servo pressure) to be supplied to the servo chamber 1A and is connected to the conduit 163. The pressure sensor 74 sends the detected signal to the brake ECU 6. The detected value of the pressure sensor 74 is an actual value of the servo pressure (corresponding to the driving force) and is referred to as the “actual servo pressure (corresponding to “actual hydraulic pressure”).

As explained, the regulator 44 includes the control piston 445 which is driven by the difference between the force corresponding to the pressure (referred to also as “pilot pressure”) in the first pilot chamber 4D and the force corresponding to the servo pressure and the volume of the first pilot chamber 4D changes in response to the movement of the control piston 445 and the more the liquid flowing into or out of the first pilot chamber 4D increases, the more the amount of the movement of the control piston 445 from the reference point thereof increases under the equilibrium state that the force corresponding to the pilot pressure balances with the force corresponding to the servo pressure. Thus, the flowing amount of the liquid flowing into or out of the servo chamber 1A is structured to be increasing.

The regulator 44 is structured so that the more the flowing amount of the liquid flowing into the first pilot chamber 4D from the accumulator 431 increases, the larger the volume of the first pilot chamber 4D becomes and at the same time the more the flowing amount of the liquid flowing into the servo chamber 1A from the accumulator 431 increases and further, the more the flowing amount of the liquid flowing out from the first pilot chamber 4D into the reservoir 171 increases, the smaller the volume of the first pilot chamber 4D becomes and at the same time the more the flowing amount of the liquid flowing out of the servo chamber 1A into the reservoir 171 increases.

Further, the control piston 445 is provided with a damper device (not shown) at the wall portion facing to the first pilot chamber 4D. The damper device is structured as a stroke simulator and is provided with a piston portion which is biased towards the first pilot chamber 4D by a biasing member. By this provision of the damper device, the rigidity of the first pilot chamber 4D is variable in response to the pilot pressure.

(Actuator 5)

The actuator 5 is provided between the first master chamber 10 and the second master chamber 1E which generate the master cylinder hydraulic pressure and the wheel cylinders 541 through 544. The actuator 5 and the first master chamber 1D are in communication through the conduit 51 and the actuator 5 and the second master chamber 1E are in communication through the conduit 52. The actuator 5 adjusts the brake hydraulic pressure to be supplied to the wheel cylinders 541 through 544 based on the instructions from the brake ECU6. The actuator 5 according to the embodiment forms an anti-lock brake system (ABS). The actuator 5 is formed with four-channel system (dual circuitry system) corresponding to the respective wheel cylinders 541 through 544. The structure of the actuator 5 is a well-known type and the detail explanation thereof will be omitted.

(Brake ECU 6)

The brake ECU 6 is an electronic control unit and includes a microprocessor. The microprocessor includes an input/output interface, CPU, RAM, ROM and a memory portion such as non-volatile memory, connected with one another through bus communication. The brake ECU 6 is connected to the various sensors 71 through 76 for controlling each of the electromagnetic valves 22, 23, 41 and 42, the motor 433 and the actuator 5 and so on. The operating amount (stroke amount) information of brake pedal 10 is inputted to the brake ECU 6 from the stroke sensor 71, an information which shows whether or not the operation of the brake pedal 10 is inputted to the brake ECU 6 from the brake stop switch 72, the reaction force hydraulic pressure information is inputted to the brake ECU 6 from the pressure sensor 73, the servo pressure information is inputted to the brake ECU 6 from the pressure sensor 74, the accumulator hydraulic pressure information is inputted to the brake ECU 6 from the pressure sensor 75 and each wheel speed information of the respective vehicle wheels 5FR, 5FL, 5RR and 5RL is inputted to the brake ECU 6 from each of the wheel speed sensors 76.

(Brake Control)

The brake control by the brake ECU 6 (normal brake control) will be explained hereinafter. The normal brake control is performed by normally controlling the hydraulic pressure braking force. In the brake control (normal mode), the brake ECU 6 energizes the first control valve 22 and opens the first control valve 22 and energizes the second control valve 23 and closes the second control valve 23. By this closing of the second control valve 23, the communication between the second hydraulic pressure chamber 1C and the reservoir 171 is interrupted and by the opening of the first control valve 22, the communication between the first hydraulic pressure chamber 1B and the second hydraulic pressure chamber 1C is established. Thus, the brake control is a mode for controlling the servo pressure of the servo chamber 1A by controlling the pressure decreasing and pressure increasing valves 41 and 42 under the first control valve 22 being opened and the second control valve 23 being closed. The pressure decreasing valve 41 and the pressure increasing valve 42 is a “valve portion” which adjusts the flow-rate of the fluid which flows into or out of the first pilot chamber 4D. Under this brake control, the brake ECU 6 calculates a required braking force required by the driver of the vehicle based on the operating amount of the brake pedal 10 detected by the stroke sensor 71 (displacement amount of the input piston 13) or the operating force of the brake pedal 10 (for example, the hydraulic pressure detected at the pressure sensor 73), according to a situation. Then, based on the calculated required braking force, the brake ECU 6 sets a target servo pressure (corresponding to “target hydraulic pressure”) which is the target value of the servo pressure. The pressure decreasing valve 41 and the pressure increasing valve 42 are controlled so that the actual servo pressure approximates the target servo pressure.

In more detail, under the state that the brake pedal 10 is not depressed, the brake control state becomes the state as explained above, i.e., becomes the state that the ball valve 442 closes the through passage 444a of the valve seat portion 444. Under this state, the pressure decreasing valve 41 is in an open state and the pressure increasing valve 42 is in a closed state. In other words, the fluid communication between the first chamber 4A and the second chamber 4B is interrupted. The second chamber 4B is in communication with the servo chamber 1A via the conduit 163 to keep the hydraulic pressures in the two chambers 4B and 1A to be mutually in an equal level. The second chamber 4B is in communication with the third chamber 4C via the passages 445c and 445d of the control piston 445. Accordingly, the second chamber 4B and the third chamber 4C are in communication with the reservoir 171 via the conduits 414 and 161. One side of the first pilot chamber 4D is closed by the pressure increasing valve 42, while the other side thereof is connected to the reservoir 171 via the pressure decreasing valve 41. The pressures of the first pilot chamber 4D and the second chamber 4B are kept to the same pressure level. The second pilot chamber 4E is in communication with the first master chamber 1D via the conduits 511 and 51 thereby keeping the pressure level of the two chambers 4E and 1D to be mutually equal to each other.

From this state, when the brake pedal 10 is depressed, the brake ECU 6 controls the pressure decreasing valve 41 and the pressure increasing valve 42 based on the actual servo pressure and the target servo pressure. Upon pressure increase, the brake ECU 6 controls the pressure decreasing valve 41 to close and the pressure increasing valve 42 to open. When the pressure increasing valve 42 is opened, a communication between the accumulator 431 and the first pilot chamber 4D is established. When the pressure decreasing valve 41 is closed, a communication between the first pilot chamber 4D and the reservoir 171 is interrupted. The pressure in the first pilot chamber 4D can be raised by the highly pressurized fluid supplied from the accumulator 431. By the increase of the pressure in the first pilot chamber 4D, the control piston 445 slidably moves towards the cylinder bottom surface side. Then the tip end of the projecting portion 445b of the control piston 445 is brought into contact with the ball valve 442 to close the passage 445d by the ball valve 442. Thus, the fluid communication between the second chamber 4B and the reservoir 171 is interrupted.

By further slidable movement of the control piston 445 towards the cylinder bottom surface side, the ball valve 442 is pushed towards the cylinder bottom surface side by the projection portion 445b to thereby separate the ball valve 442 from the valve seat surface 444b. This will allow establishment of fluid communication between the first chamber 4A and the second chamber 4B through the through passage 444a of the valve seat portion 444. As the highly pressurized fluid is supplied to the first chamber 4A from the accumulator 431, the hydraulic pressure in the second chamber 4B is also increased by the communication therebetween. It is noted that the more the separated distance of the ball valve 442 from the valve seat surface 444b becomes large, the more the fluid passage for the fluid becomes large and accordingly, the flow-rate of the fluid in the fluid passage downstream of the ball valve 442 becomes high.

The brake ECU 6 controls the pressure increasing valve 42 and at the same time closes the pressure decreasing valve 41 such that the larger the displacement amount of the input piston 13 (operating amount of the brake pedal 10) detected by the stroke sensor 71, the higher the pilot pressure in the first pilot chamber 4D becomes. In other words, the larger the displacement amount of the input piston 13 (operating amount of the brake pedal 10), the higher the pilot pressure becomes and accordingly, the higher the actual servo pressure becomes. The actual servo pressure can be obtained from the pressure sensor 74 and can be converted into the pilot pressure.

As the pressure increase of the second chamber 4B, the pressure (actual servo pressure) in the servo chamber 1A which is in fluid communication with the second chamber 4B increases. By the pressure increase in the servo chamber 1A, the first master piston 14 advances forward and the pressure (master pressure) in the first master chamber 1D increases. Then the second master piston 15 advances forward also and the pressure (master pressure) in the second master chamber 1E increases. By the increase of the pressure (master pressure) in the first master chamber 1D, highly pressurized fluid (master pressure) is supplied to the actuator 5 and the second pilot chamber 4E. The pressure in the second pilot chamber 4E increases, but since the pressure in the first pilot chamber 4D is also increased, the sub piston 446 does not move. Thus, the highly pressurized (master pressure) fluid is supplied to the actuator 5 and a friction brake is operated to control brake operation of the vehicle. When the brake operation is released, as opposite to the above, the pressure decreasing valve 41 is open and the pressure increasing valve 42 is closed to establish the fluid communication between the reservoir 171 and the first pilot chamber 4D. Then, the control piston 445 retreats and the vehicle returns to the state before depression of the brake pedal 10.

(Reaction Force Chamber Opening Mode)

On the other hand, under the first control valve 22 being in a closed state (non-energized state) and at the same time under the second control valve 23 being in an open state, the first hydraulic pressure chamber 19 becomes a sealed state and the second hydraulic pressure chamber 1C is in communication with the reservoir 171. Under this state, when the brake pedal 10 is operated, the first master piston 14 is co-operated with the advance movement of the input piston 13 and advances integrally with the input piston 13 (in mutually non-contact state). At this time, since the second hydraulic pressure chamber 1C is in communication with the reservoir 171, substantially no reaction force hydraulic pressure is generated. The fluid corresponding to the volume decreased worth in the second hydraulic pressure chamber 1C flows out and flows into the reservoir 171 via the second control valve 23. Then, the generated master pressure generated by the advance movement of the first master piston 14 is supplied to the actuator 5 and the second pilot chamber 4E via the conduits 51, 52 and 511. Thus, it is possible to generate a braking force only by operating the brake pedal 10. This state (or the control) is referred to as the “reaction force chamber opening mode” and the mode in which the brake control is executed by the brake ECU 6 is referred to as the “normal mode”. It is noted here that in this reaction force chamber opening mode, when the first control valve 22 is in the open state or when the first control valve 22 does not exist (not provided), the first master piston 14 does not advance forward until the input piston 13 is brought into contact with the first master piston 14 and pushes the first master piston 14. The stroke until the input piston 13 is brought into contact with the first master piston 14 is defined to be the “invalid stroke”.

As explained above, the vehicle braking device A according to the embodiment includes an reaction force chamber R (1B, 1C, 214, 164, 162) in which a reaction force hydraulic pressure is generated in response to an operating amount of a brake operating member 10, a low pressure source 171 which communicates with the reaction force chamber R under a predetermined condition, a master cylinder 1 having a master chamber 1D, 1E in which a master hydraulic pressure (master pressure) is generated by being driven by a master piston 14, 15, a drive chamber 1A (servo chamber according to this embodiment) which generates a driving hydraulic pressure (servo pressure according to this embodiment) for driving the master piston 14, 15 in response to the operating amount of the brake operating member 10, a valve portion 41, 42 which adjusts a flowing-in and flowing-out amount of fluid relative to the drive chamber 1A, a control portion 6 (61) which sets a target hydraulic pressure which is a target value of the driving hydraulic pressure or the master hydraulic pressure based on at least one of the operating amount and an operating force of the brake operating member 10 and controls the valve portion 41, 42 to make an actual hydraulic pressure which is an actual value of the driving hydraulic pressure or the master hydraulic pressure relative to the target hydraulic pressure approximate the target hydraulic pressure, a stroke sensor 71 which detects the operating amount of the brake operating member 10, a pressure sensor 73 which detects the reaction force hydraulic pressure and an electromagnetic valve 23 which is disposed between the reaction force chamber R and a reservoir 173. According to this embodiment, at least one of the drive chamber (servo chamber 1A) and the valve portion (pressure decreasing valve 41 and the pressure increasing valve 42) forms a driving portion Y which generates a driving force for driving the master piston. In other words, the control portion 6 (61) sets a target value for the driving force or the master hydraulic pressure based on at least one of the operating amount and the operating force of the brake operating member 10 and controls the driving portion Y to make the actual value of the driving force or the master hydraulic pressure relative to the target value approximate the target value.

(Abnormality Diagnosis)

The brake ECU 6 includes as a function, the control portion 61 which executes the brake control explained above, a diagnosis portion 62 which executes an abnormality diagnosis and a judging portion 63 which judges the state of the reaction force chamber R. The control portion 61 as explained above, sets the target servo pressure and controls the pressure decreasing valve 41 and the pressure increasing valve 42 to make the actual servo pressure approximate the target servo pressure. The control portion 61 executes a feed-back control. The diagnosis portion 62 and the judging portion 63 form the abnormality diagnosis device C.

The diagnosis portion 62 executes an abnormality diagnosis based on at least one of “a relationship between the operating amount of the brake pedal 10 (hereinafter, also referred to simply as “stroke”) and the reaction force hydraulic pressure” and “a relationship between the target servo pressure and the actual servo pressure”. In more detail, the diagnosis portion 62, as shown in FIG. 3, diagnoses as an abnormality when the detection result (reaction force hydraulic pressure) of the pressure sensor 73 relative to the detection result (stroke) of the stroke sensor 71 indicates a value outside a normal range which is set per every stroke for a predetermined time period or more, i.e., the diagnosis portion 62 diagnoses as an abnormality when the detected value of the pressure sensor 73 relative to the detected value of the stroke sensor 71 exceeds a permissible upper limit value set per every stroke for a predetermined time period or more or falls below a permissible lower limit value set per every stroke for a predetermined time period. The normal range is a range between the permissible lower limit value and the permissible upper limit value.

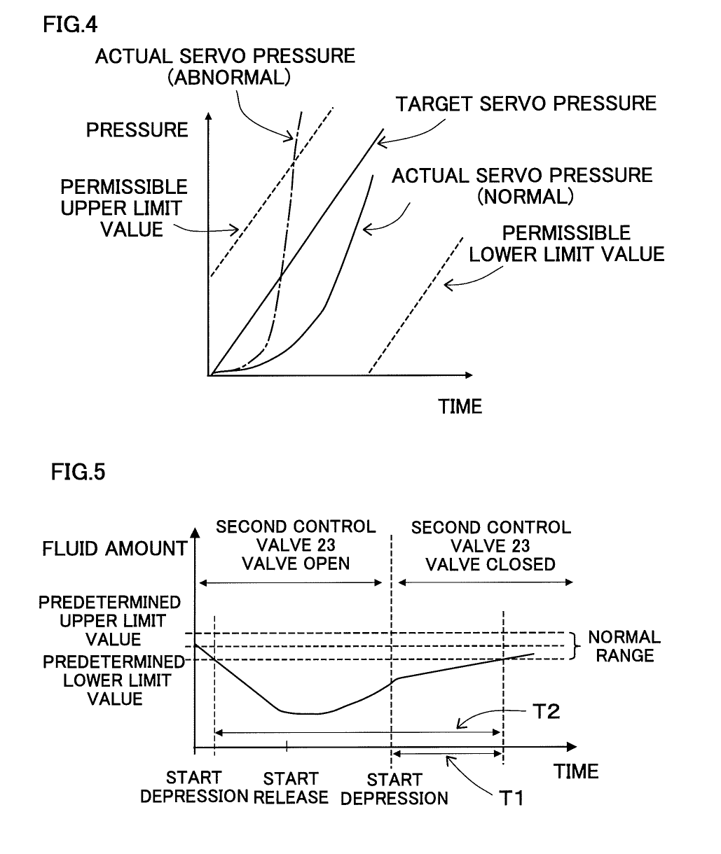

Further, the diagnosis portion 62, as shown in FIG. 4, diagnoses as an abnormality when the actual servo pressure (the detected value of the pressure sensor 74) relative to the target servo pressure indicates a value outside a normal range (from the permissible lower limit value to the permissible upper limit value) which is set in response to an inclination of the target servo pressure for a predetermined time period or more. As an alternative, the diagnosis portion 62 may diagnose as an abnormality when the difference between the target servo pressure and the actual servo pressure indicates a value equal to or more than a permissible value for a predetermined time period or more. The diagnosis portion 62 executes an abnormality diagnosis every predetermined interval of time. The diagnosis portion 62 notifies the driver of the vehicle that an abnormality has occurred by means of information means (not shown) when judged that an abnormality has occurred.

The judging portion 63 judges whether the state of the reaction force chamber R regarding to at least one of the hydraulic pressure and the amount of fluid is in a predetermined insufficient state or in a predetermined excess state. The “predetermined insufficient state” means the state that the amount of fluid in the reaction force chamber R is less than a predetermined lower limit value or the state that the reaction force hydraulic pressure in the reaction force chamber is less than a predetermined lower limit pressure. The “predetermined insufficient state” can be expressed as a state that the amount of fluid in the reaction force chamber R is smaller than the amount under an initial state (steady-state). The “predetermined excess state” means the state that the amount of fluid in the reaction force chamber R is more than a predetermined upper limit value or the state that the reaction force hydraulic pressure in the reaction force chamber R is more than a predetermined upper limit pressure. The “predetermined excess state” can be expressed as a state that the liquid amount (fluid amount) in the reaction force chamber R is more than the amount under an initial state (steady-state). It is noted that according to this embodiment, the state of the reaction force chamber R is judged whether the state is in the insufficient state or the excess state based mainly on the amount of fluid (liquid) in the reaction force chamber R.

In more detail, the judging portion 63 obtains the information on the fluid communication between the reaction force chamber R and the reservoirs 171 through 173 and based on the obtained information on fluid communication and at least one of the detection result (stroke) of the stroke sensor 71 and the detection result (reaction force hydraulic pressure) of the pressure sensor 73, the judging portion 63 judges the state of the reaction force chamber R. Further in detail, the judging portion 63 obtains the opening and closing record (history) of the second control valve 23 as the information on the fluid communication and based on the obtained opening and closing record and at least one of the stroke and the reaction force hydraulic pressure, the judging portion 63 judges the state of the reaction force chamber R. When the second control valve 23 is opened, the fluid communication between the reaction force chamber R and the reservoir 171 is established. In other words, under the state that the second control valve 23 is opened (under the predetermined condition), the reaction force chamber R and the reservoir 171 fluidically communicate with each other. The opening and closing of the second control valve 23 are controlled by the instructions (control current) of the control portion 61 and the record thereof (instruction information) is memorized in the memory portion of the brake ECU 6.

The judging portion 63 obtains the information on establishment/interruption of fluid communication between the reaction force chamber R and the reservoir 173 from the memorized opening and closing record of the second control valve 23. It is noted that hereinafter the state that the second control valve 23 is open is referred to as “reservoir communication established state” and the state that the second control valve 23 is closed is referred to as “reservoir communication interrupted state”. The brake ECU 6 of this embodiment closes the first control valve 22 under the reservoir communication established state and opens the first control valve 22 under the reservoir communication interrupted state. Under the reservoir communication interrupted state, the judging portion 63 according to this embodiment judges the state of the reaction force chamber R at a current state (here, under the reservoir communication interrupted state) based on the opening and closing record, stroke under the reservoir communication established state and the reaction force hydraulic pressure under the reservoir communication established state.

The judging portion 63 calculates (presumes) the flowing-out amount of fluid to the reservoir 173 from the reaction force chamber R based on the forward stroke (depression operating amount) and the reaction force hydraulic pressure in the period of reservoir communication established state. In more detail, the judging portion 63 considers (excludes) the consumption amount of fluid at the stroke simulator 21 caused by the forward stroke and calculates the flowing-out amount of fluid based on the difference in pressure between the reaction force hydraulic pressure and the pressure (atmospheric pressure) in the reservoir 173.

Still further, the judging portion 63 calculates (presumes) the flowing-in amount of fluid to the reaction force chamber R from the reservoir 173 based on the rearward stroke (returning operating amount) and the reaction force hydraulic pressure in the period of reservoir communication established state. The judging portion 63 calculates the flowing-in amount of fluid based on the rearward stroke and the difference in pressure between the reaction force hydraulic pressure and the pressure (atmospheric pressure) in the reservoir 173. The judging portion 63 judges whether the state of the reaction force chamber R is in a predetermined insufficient state or not based on the calculated flowing-out and flowing-in amount of the fluid. The judging portion 63 considers the at least one of the fluid passage (orifice effect at the second control valve 23) between the reaction force chamber R and the reservoir 173, difference in pressure and the viscosity of fluid and calculates the flowing-in and flowing-out amount of fluid in the reaction force chamber R. It is noted that the flowing-in and flowing-out amount of fluid in the reaction force chamber R may be calculated from the data base obtained in advance by an experimental work or the like for example, from the stroke change amount, reaction force hydraulic pressure change amount and the period of the reservoir communication established state. It is also noted that the flowing-out amount of fluid may be calculated considering the opening and closing state (the opening and closing record) of the first control valve 22 when the first control valve 22 is opening/closing controlled under the reservoir communication established state.

The judging portion 63 continues to calculate the flowing-in and flowing-out amount of fluid, including the time period until the calculated fluid amount in the reaction force chamber R returns to the value within the normal range (the range between the predetermined lower limit value and the predetermined upper limit value) after the second control valve 23 has been closed. Even under the state that the second control valve 23 has been closed, if the reaction force chamber R is in a vacuum state, the fluid flows into the reaction force chamber R from the reservoir 173, for example, via the passage 18. Under such situation, since the flowing-in amount is restricted due to the orifice effect of the passage 18 and the first control valve 22 and it may take a longer time to return to the normal state. The judging portion 63, for example, calculates the fluid amount of the reaction force chamber R after the closing of the second control valve 23 based on the difference in pressure between the reaction force chamber R and the reservoir 173 and the flowing-in amount (flowing-in amount of fluid via the passage 18) per unit time caused by the difference in pressure. The judging portion 63 upon calculation of the flowing-in and flowing-out amount of fluid, can consider the fluid flowing therein via the sealing members 91, 95 from the reservoir 171 through 173. The judging portion 63 regardless of the opening and closing state of the second control valve 23, can calculate the flowing-in and flowing-out amount of fluid at every different time point and can judge the state of the reaction force chamber R at every calculation of the flowing-in and flowing-out amount of fluid. It is noted that the judging portion 63 may calculate (presume) the time that the fluid amount in the reaction force chamber R returns to a value within the normal range, upon closing of the second control valve 23.

The judging portion 63 sends the signal that prohibits the execution of abnormality diagnosis to the diagnosis portion 62 when the judging portion 63 judges that the state of the reaction force chamber R is in the predetermined insufficient state under the reservoir communication interrupted state. On the other hand, the judging portion 63 sends the signal that permits the execution of abnormality diagnosis to the diagnosis portion 62 when the judging portion 63 does not judge that the state of the reaction force chamber R is in the predetermined insufficient state under the reservoir communication interrupted state. The diagnosis portion 62 executes or stops the abnormality diagnosis based on the permission signal/prohibiting signal from the judging portion 63. In other words, the diagnosis portion 62 stops the abnormality diagnosis when the judging portion 63 judges that the state of the reaction force chamber R is in the predetermined insufficient state.

It is noted that one example in which the state of the reaction force chamber R becomes the predetermined insufficient state will be explained with reference to FIG. 5. As shown in FIG. 5, under the reservoir communication established state (the state that the second control valve 23 is opened and the first control valve 22 is closed), when the brake pedal 10 is depressed and the input piston 13 advances forward, the fluid responding to the stroke is discharged to the reservoir 173 via the second control valve 23. In other words, under the reservoir communication established state, when the brake pedal 10 is deeply depressed, the first master piston 14 advances forward in co-operation with the advance movement of the input piston 13. Thus, the volume of the second hydraulic pressure chamber 1C decreases (the space of the reaction force chamber R is decreased) due to the advance movement thereof and then the fluid in the reaction force chamber R is discharged to the reservoir 173 via the second control valve 23.

Sequentially, when the brake pedal 10 is returned suddenly (when the brake pedal 10 is released quickly), the first master piston 14 retreats and due to such retreatment of the first master piston 14, the volume of the second hydraulic pressure chamber 1C increases toward the initial state (expands the reaction force chamber R) to thereby reduce the pressure in the reaction force chamber R (here, becomes the vacuum state). Then, due to the difference in pressure between the reaction force chamber R and the reservoir 173, the fluid in the reservoir 173 flows into the reaction force chamber R via the second control valve 23. It is noted that an orifice effect is generated due to the difference in width of the fluid path between the second control valve 23 and the conduit 161 at the second control valve 23. Thus, the amount of fluid flowing into the reaction force chamber R is restricted and a timing delay occurs for clearing the pressure difference (vacuum in the reaction force chamber R) between the reaction force chamber R and the reservoir 173 relative to the returning operation of the brake pedal 10.

Then, under the situation that the pressure difference exists, when the second control valve 23 is closed and the state is transferred to the reservoir communication interrupted state (the state that the second control valve 23 is closed and the first control valve 22 is opened), due to the above pressure difference (the state that the fluid in the reaction force chamber R is insufficient), the fluid in the reservoir 173 flows into the reaction force chamber R via the passage 18. However, also in this situation, since the amount of the fluid flowing into the reaction force chamber R is restricted by the orifice effect at the passage 18 and the first control valve 22, it takes time to dissolve the pressure difference. In other words, according to the vehicle braking device A, a time period in which the pressure difference is not dissolved, i.e., a time period in which the fluid in the reaction force chamber R is less than the fluid in the normal situation occurs. The second control valve 23 is controlled to be closed from the open state is the time when the brake pedal 10 is depressed again after a sudden returning operation of the brake pedal 10, for example, when the mode is switched over from the reaction force chamber opening mode (mode that the braking force is generated without opening the pressure increasing valve 42) to the normal mode (mode that executes the above brake control). Before the fluid returns to the reaction force chamber R completely, if the control mode is switched over (when the second control valve 23 is controlled to be closed from the opening state), the fluid insufficient state time period occurs at the reaction force chamber R.

While the time period in which the fluid in the reaction force chamber R is insufficient, when the brake pedal 10 is operated, the input piston 13 is relatively smoothly advances forward due to the insufficiency of fluid in the reaction force chamber R and consumes the stroke more than a normal situation. In other words, with the same brake pedal 10 operation, the stroke becomes larger than the normal brake pedal 10 operation. Therefore, even no failure occurs, the “relationship between the stroke and the reaction force hydraulic pressure” changes largely compared to the normal time relationship. Further, when the brake pedal 10 is operated under the fluid insufficient state, the reaction force hydraulic pressure is not increased but the stroke increases largely. Under such situation, the input piston 13 and the first master piston 14 may be brought into contact with each other and if such contact occurs, the first piston 14 advances forward by the pushing of the input piston 13 (depression force by the driver of the vehicle). Then, the master pressure increased by the advancement of the first master piston 14 is supplied to the second pilot chamber 4E and the actual servo pressure increases regardless of the controlling. Accordingly, even there occurs no failure, it may possibly diagnosed to be a pressure increasing abnormal state. In other words, even in such case, the “relationship between the target servo pressure and the actual servo pressure” changes largely compared to the normal time relationship. The “relationship between the target master pressure and the actual master pressure” also changes similarly. As explained, under the fluid insufficient state, the diagnosis portion 62 may possibly miss-diagnose.

Here, the judging portion 63 considers the opening and closing of the second control valve 23 and the orifice effect and calculates the flowing-in and flowing-out fluid relative to the reaction force chamber R with the above consideration, wherein the judging portion 63 judges that the state of the reaction force chamber R is in a “predetermined insufficient state”, when the fluid amount in the reaction force chamber R is less than the predetermined lower limit value. Further the judging portion 63 calculates the fluid amount in the reaction force chamber R at current time based on the decreased fluid amount (insufficient fluid amount) in the reaction force chamber R, the pressure difference and the orifice effect at the passage 18 or the like under the reservoir communication interrupted state. The judging portion 63 judges that the state of the reaction force chamber R is in the “predetermined insufficient state” until the fluid amount in the reaction force chamber R returns to a value within a normal range. In other words, for the time period of T1 shown in FIG. 5, the judging portion 63 judges that the state of the reaction force chamber R is in the predetermined insufficient state. Thus, diagnosing of abnormality under the fluid insufficient state of the reaction force chamber R stops. It is noted that the judging portion 63 can calculates the fluid amount of the reaction force chamber R upon valve opening state of the second control valve 23 and accordingly, the judging portion 63 may judge that the state of the reaction force chamber R is in the predetermined insufficient state for the time period T2 shown in FIG. 5 including the period of opening state of the second control valve 23 (under the reservoir communication established state). However, when the subject of the abnormality diagnosis is the normal brake control (normal mode), it is sufficient for the judging portion 63 to judge the state of the predetermined insufficient state only for the time period T1. It is noted that the fluid amount shown in FIG. 5 is an conceptual amount (image) illustrated for explaining purpose.

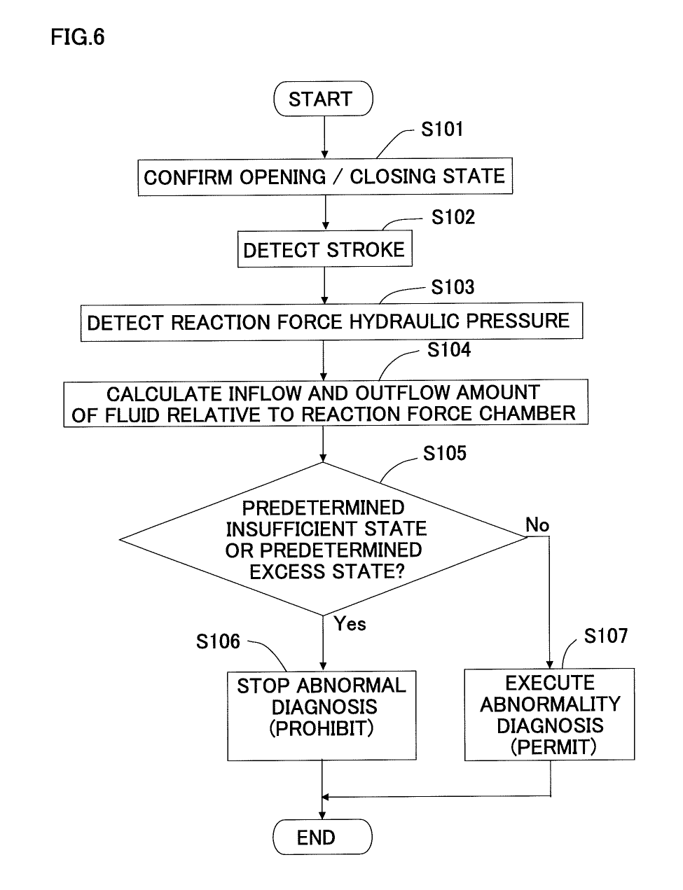

The flow of state judgement of the reaction force chamber R for the abnormality diagnosis will be explained with reference to FIG. 6. First, the judging portion 63 confirms (judges) the opening and closing state of the second control valve 23 at the current time based on the control situation of the control portion 61 or the opening and closing record (S101). The judging portion 63 obtains the information on the stroke from the stroke sensor 71 (S102) and obtains the information on the reaction force hydraulic pressure from the pressure sensor 73 (S103). Then, the judging portion 63 calculates or presumes the flowing-in and flowing-out amount of fluid relative to the reaction force chamber R at the current time based on the opening and closing record, the stroke and the reaction force hydraulic pressure (S104). The judging portion 63 judges whether or not the state of the reaction force chamber R is in smaller than a predetermined state or larger than a predetermined state based on the calculation result (S105). When the judging portion 63 judges that the state of the reaction force chamber R is in the predetermined insufficient state or the predetermined excess state (S105: Yes), sends a diagnosis prohibiting signal to the diagnosis portion 62 and the diagnosis portion 62 stops abnormality diagnosing (S106). On the other hand, when the judging portion 63 does not judge that the state of the reaction force chamber R is in the predetermined insufficient state or the predetermined excess state, (S105: No), sends a diagnosis permitting signal to the diagnosis portion 62 and the diagnosis portion 62 executes abnormality diagnosing (S107). This process is repeated on a steady basis (per every predetermined time).

According to the embodiment, in a system where the reaction force chamber R and the reservoir 173 are hydraulically communicable, when the fluid state of the reaction force chamber R becomes in a fluid insufficient state (less fluid state), the abnormality diagnosis stops. Accordingly, an erroneous detection (erroneous diagnosis, erroneous diagnosing) at the execution of abnormality diagnosis caused by an excess depression of the brake pedal 10 at the insufficient fluid state, not caused by an occurrence of a failure, can be suppressed. By such suppression of the erroneous detection, the accuracy of abnormality diagnosis can be improved. Further, when the insufficient state of the reaction force chamber R is released, the abnormality diagnosis can be allowed to quickly re-start the abnormality diagnosis to thereby improve safety of the system. As explained above, according to the embodiment, considering the fluid communication state between the reaction force chamber R and the reservoir 173, the decision whether or not to execute the abnormality diagnosis is made and accordingly, more reliable abnormality diagnosis can be realized.

Further, according to the embodiment, by the opening and closing of the second control valve 23, the establishment and the interruption of the fluid communication between the reaction force chamber R and the reservoir 173 is controlled. Therefore, by referencing the opening and closing record of the second control valve 23, the fluid flowing-in and flowing-out amount relative to the reaction force chamber R can be calculated. By using the opening and closing record as the calculation element, the accuracy of the calculation on the flowing-in and flowing-out amount of fluid can be improved.

According to the embodiment, mainly the judgement on the predetermined insufficient state has been explained. Hereinafter, the judgement on the “predetermined excess state” will be explained. As explained above, the predetermined excess state means the state that the fluid state of the reaction force chamber R is in a fluid excess state. For example, such fluid excess state may occur by consecutively depressing the brake pedal 10, performing such as a so-called pumping operation (in a case where the input piston 13 repeats advance movement and retreat movement in a very short time period without returning to the initial position), during a normal brake control (normal mode: first control valve 22 is open and the second control valve 23 is closed).

In detail, in this situation, during the consecutive operation, at least one of the first hydraulic pressure chamber 1B and the second hydraulic pressure chamber 1C becomes transitionally a vacuum state and in this transitional vacuum state, fluid may flow out of the reservoir 171 through 173 and flows into the reaction force chamber R via the sealing members 91, 95, etc. In other words, when the reaction force chamber R is in a vacuum state (corresponding to the “predetermined condition”) the reaction force chamber R and the reservoir 171 through 173 are in fluid communication with each other via the sealing members 91, 95. Thus, the fluid amount in the reaction force chamber R becomes increased and in spite of small stroke, the reaction force hydraulic pressure becomes large. The judging portion 63 presumes the period of vacuum state and calculates the fluid amount flowing into via the sealing members 91, 95 for the time period (communication established period). The flowing-in amount through the sealing members 91, 95 can be set in advance by experimental work or the like. The judging portion 63 for example, uses the “information on communication relating to the communication state” as the judgement whether the reaction force chamber R is in a vacuum state or not, based on the detection result from the pressure sensor 73 and judges that the valium state is the state that the reaction force chamber R and the reservoir 171 through 173 are in fluid communication, to thereby calculate the flowing-in and flowing-out amount of fluid. The judging portion 63 calculates the flowing-in and flowing-out amount of fluid assuming that the period of vacuum state is the communication established period. The judging portion 63 judges whether the state of the reaction force chamber R is in the predetermined excess state or not based on the calculation result.

(Others)

The invention is not limited to the embodiment explained above. For example, the reaction force hydraulic pressure can be presumed (calculated) from the stroke. In such case, the pressure sensor 73 can be omitted from the structure. Further, in the hydraulic braking force generating device BF, the first control valve 22 may be omitted from the structure. Still further, the judgement of abnormality diagnosis or whether or not the execution of abnormality diagnosis is allowed may be executed at another ECU different from the brake ECU 6. The judging portion 63 may judge whether the abnormality diagnosis may be executed or not based on the reaction force hydraulic pressure (detected value of the pressure sensor 73) without using the stroke. Further, the regulator 44 may be a type using a spool valve.

According to the embodiment explained above, as the driving portion Y for generating a driving force of the master piston (14), a drive chamber 1A in which the drive hydraulic pressure is generated and a valve portion 41, 42 which adjusts the flowing-in and flowing-out amount of fluid relative to the drive chamber 1A are adopted. However, the driving portion Y is not limited to this structure and as the driving portion Y, an electric driving portion having an electromagnetic actuator such as an electric motor can be applicable which applies the driving force in response to the operating amount of the brake operating member 10 to the master piston (14).

### REFERENCE SIGNS LIST

1; master cylinder, 11; main cylinder, 12; cover cylinder 13; input piston, 14; first master piston, 15; second master piston, 1A; servo chamber, 1B; first hydraulic pressure chamber (reaction force chamber), 1C; second hydraulic pressure chamber (reaction force chamber), 1D; first master chamber, 1E; second master chamber, 10; brake pedal (brake operating member), 171, 172, 173, 434; reservoir (low pressure source), 2; reaction force generating device, 22; first control valve, 23; second control valve, (electromagnetic valve), 4; servo pressure generating device, 41; pressure decreasing valve, 42; pressure increasing valve, 431; accumulator (high pressure source), 44; regulator, 445; control piston, 4D; first pilot chamber, 5; actuator, 541, 542, 543, 544; wheel cylinder, 5FR, 5FL, 5RR and SRL; wheel, BF; hydraulic pressure braking force generating device, 6; brake ECU, 61; control portion, 62; diagnosis portion, 63; judging portion, 71; stroke sensor, 73, 74, 75; pressure sensor, 76; wheel speed sensor, A; vehicle braking device, C; abnormality diagnosis device, R; reaction force chamber, Y: driving portion.

1. An abnormality diagnosis device applied to a vehicle braking device which includes:
a reaction force chamber in which a reaction force hydraulic pressure is generated in response to an operating amount of a brake operating member;
a low pressure source which communicates with the reaction force chamber under a predetermined condition;
a master cylinder having a master chamber in which a master hydraulic pressure is generated by being driven by a master piston;
a driving portion which generates a driving force for driving the master piston in response to the operating amount of the brake operating member; and
a control portion which sets a target value of the driving force or the master hydraulic pressure based on at least one of the operating amount of the brake operating member and an operating force of the brake operating member and controls the driving portion to make an actual value of the driving force or the master hydraulic pressure relative to the target value approximate the target value, the abnormality diagnosis device comprising:
a diagnosis portion which performs an abnormality diagnosis based on at least one of a relationship between the operating amount of the brake operating member and the reaction force hydraulic pressure and a relationship between the target value and the actual value; and
a judging portion which judges whether a state of the reaction force chamber with respect to at least one of a hydraulic pressure and an amount of fluid therein is in a predetermined insufficient state or in a predetermined excess state, wherein
the diagnosis portion stops performance of the abnormality diagnosis when the state of the reaction force chamber with respect to the at least one of the hydraulic pressure and the amount of fluid therein is judged by the judging portion to be in the predetermined insufficient state or in the predetermined excess state.

2. The abnormality diagnosis device according to claim 1, wherein:
the vehicle braking device includes at least one of a stroke sensor which detects the operating amount of the brake operating member and a pressure sensor which detects the reaction force hydraulic pressure and wherein
the judging portion obtains an information on a communication state between the reaction force chamber and the low pressure source and judges the state of the reaction force chamber based on the information on the communication state and at least one of a detection result from the stroke sensor and a detection result from the pressure sensor.

3. The abnormality diagnosis device according to claim 2, wherein
the vehicle braking device includes an electromagnetic valve disposed between the reaction force chamber and the low pressure source and wherein
the judging portion uses an opening and closing record of the electromagnetic valve as the information on the communication state.
